(19) United States
(12) Patent Application Publication
(10) Pub. No.: US 2004/0237379 A1
(43) Pub. Date: Dec. 2, 2004

(54) Insect traps

(76) Inventor: Roger H. Long, Hernando, FL (US)

Correspondence Address: RICHARD O. CHURCH, 19 WESTVIEW TERRACE, WOMELSDORF, PA, 19567, US

(21) Appl. No.: 10/831,904

(22) Filed: Apr. 26, 2004

Related U.S. Application Data
(60) Provisional application No. 60/473,411, filed on May 28, 2003.
(60) Provisional application No. 60/547,164, filed on Feb. 25, 2004.

(51) Int. Cl. A01M 1/20

(52) U.S. Cl. 43/107

(57) ABSTRACT

An insect trap having an airtight sealing mechanism that can be opened and resealed to turn the trap “on” or “off.”

### HISTORY OF THE APPLICATION

This application is based upon and claims priority from U.S. Provisional Patent Applications Ser. No. 60/473,411 filed May 28, 2003 and Ser. No. 60/547,164 filed Feb. 25, 2004.

### BACKGROUND OF THE INVENTION

The invention relates to the design of insect traps of the kind that entice insects to enter an enclosure, contain the insects within the enclosure and cause the insects to die within the enclosure. The traps of this invention are used to reduce a localized population of common flying nuisance insects such as flies, yellow jackets, Japanese beetles, moths, etc. The traps are baited with attractants that emit odors which, for various reasons, gain the favorable attention of an insect and cause the insect to seek out the source of the odor. The traps are designed to make it relatively easy for an insect to enter a trap but, once inside, make it more difficult for the insect to find its way out. Baffles, conical passageways, small openings and the like will serve this purpose. Once inside the trap, an insect is killed as by drowning, poisoning or exhaustion.

It is necessary for the trap to have openings from which the odors produced within the trap may escape. These openings are conveniently the same openings through which insects find their ways into the trap. Some traps have entry holes for the insects located at or near the top of the trap while others position the entry holes nearer to or at the bottom, all depending on the observed behavior of the insect involved. The traps of this invention are of the top entry type and are exemplified as traps for flies, although, depending on the attractant used and the placement and design of the openings, the traps can be useful for capturing other insects.

The traps and the insects must be disposed of when the trap is filled with dead insects. Either the insect containment bag is detached from the entry fixture and thrown away or, alternatively, the entire trap is discarded.

Two early examples of top entry traps which make use of disposable containment bags are to be found in U.S. Pat. Nos. 1,005,530 and 2,809, 465. The containment bags are suspended from an entry fixture of the trap and can be removed, discarded and replaced to resume further use of the insect trap.

The same feature of a throw away containment bag is disclosed in U.S. Pat. No. 4,706,410. The patent is of additional interest for its showing of a conical entry fixture which includes baffles that divide the entry fixture into four quadrants. The purpose of the baffles is to confuse an insect and make it more difficult for the insect to find its way out of the trap.

U.S. Pat. No. 4,899,485 makes use of a containment bag that is fixedly attached to and hangs down from an entry fixture. The trap is inexpensively made so that it may be discarded in its entirety when it is filled with insects.

In U.S. Pat. No. 5,392,558 patentee discloses a disposable insect trap which, like the trap of the '485 patent is meant to be discarded after use. The entry fixture of the '558 patent suspends the containment bag from a baffled entry port that slides up and down to open or close the entry port. The entry port is opened for use and closed for disposal. When the trap is suspended and the containment bag is charged with an attractant, the entry port is held open by gravity pulling the containment bag down. No provision is made to secure or seal the entry port after it is returned to a closed position.

In the prior art it is a known practice for a supplier to include insect attractants within a containment bag. In the case of powder based attractants, the powdered baits con be packaged in water soluble films, placed in the containment bag and activated for use by the consumer when water is added to the bag. Since both the attractant and its packaging material may be moisture sensitive, the containment bag needs to be hermetically sealed to provide a long shelf life.

The attractants in the containment bag also will usually include an insecticide or a drowning agent. Insecticides are just what their name suggests and a drowning agent is simply a surfactant. Surfactants reduce the surface tension of a liquid. Then when an insect contacts the liquid, its wings are wet out, it can no longer fly and it will drown in the trap.

The prior art adequately deals with the problem of sealing the containment bag of the trap until it is ready for use as, for example, by surrounding the entry fixture within a moisture barrier such as a heat/shrink plastic film. To ready the trap for use, the moisture barrier is destructively removed. Once the seal is broken, the insect rap can not be resealed for storage, relocating the trap or sanitary disposal.

While the use of an impervious film barrier protects the contents of a trap prior to use, it does not provide for a safe and sanitary method for disposing of dead insects along with the residues of liquid attractants, odors and poisons. Many insects, especially flies, carry germs that can cause disease and pathogens may breed within a trap. The inability to reseal a trap can make it unpleasant and hazardous to ones health when relocating, transporting or disposing of used insect traps and their containment bags. Leaks or spills from the containment bags will continue to attract insects and cause them to congregate at a disposal site and give rise to safety concerns respecting health, sanitation, noxious odors and environmental contamination.

Stated somewhat differently, the prior art does not disclose an insect trap that alternately can be turned “on” and “off”—that is, opened and then resealed for later use. In contrast, the trap of this invention is hermetically sealed when turned “off” and noxious odors will not emanate from the trap nor can the contents of the trap spill out. This feature permits one to use the trap for an occasion such as a picnic and then turn it “off” for safe storage until another occasion arises. So too, when a trap is filled with insects, it can be turned “off” to provide for safe disposal without continuing to attract insects at the disposal site.

It is important to note that when a trap is turned to the “off” position, the contents of the collection chamber may continue to produce affractant gases. This makes it necessary for the seal to be of sufficient strength and efficiency to withstand any partial pressure of gases developed within the bag.

### SUMMARY OF THE INVENTION

The present invention is concerned with the design of insect traps that can be opened and then resealed or, it may be said, turned “on” and “off.”

### BRIEF DESCRIPTION OF THE SEVERAL VIEWS

The invention can be understood more clearly from a description of the drawings in which:

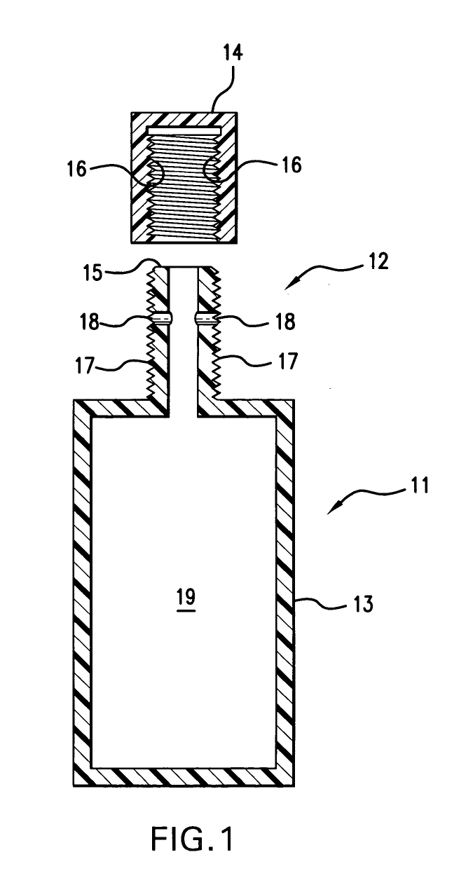

FIG. 1 is a sectional view of a device of this invention.

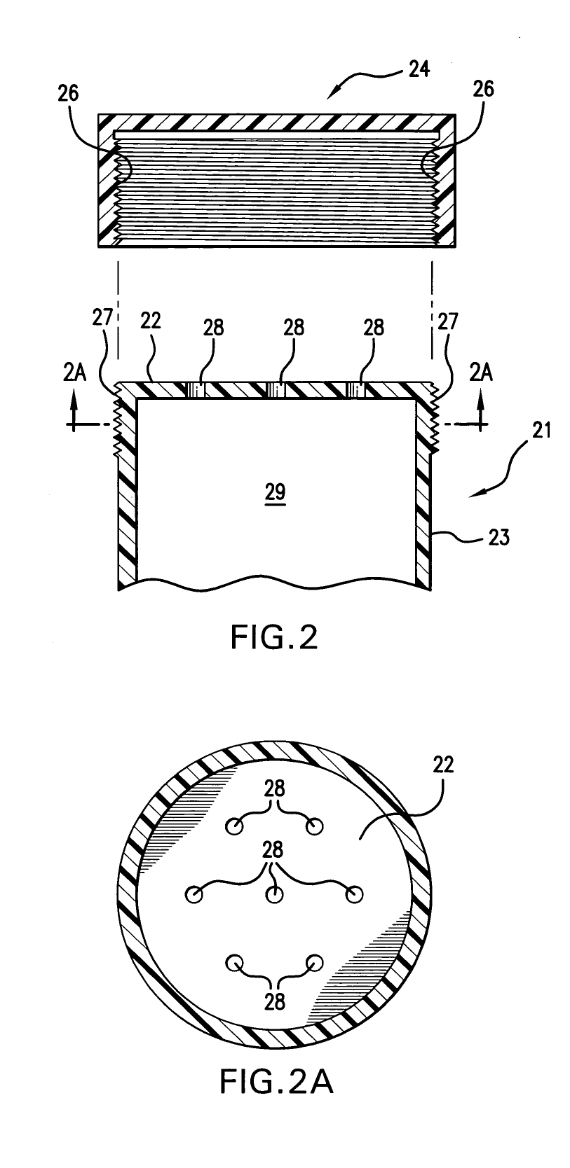

FIG. 2 is sectional view, partially broken away, of another device of this invention.

FIG. 2a is a top plan view of a detail of the device of FIG. 2.

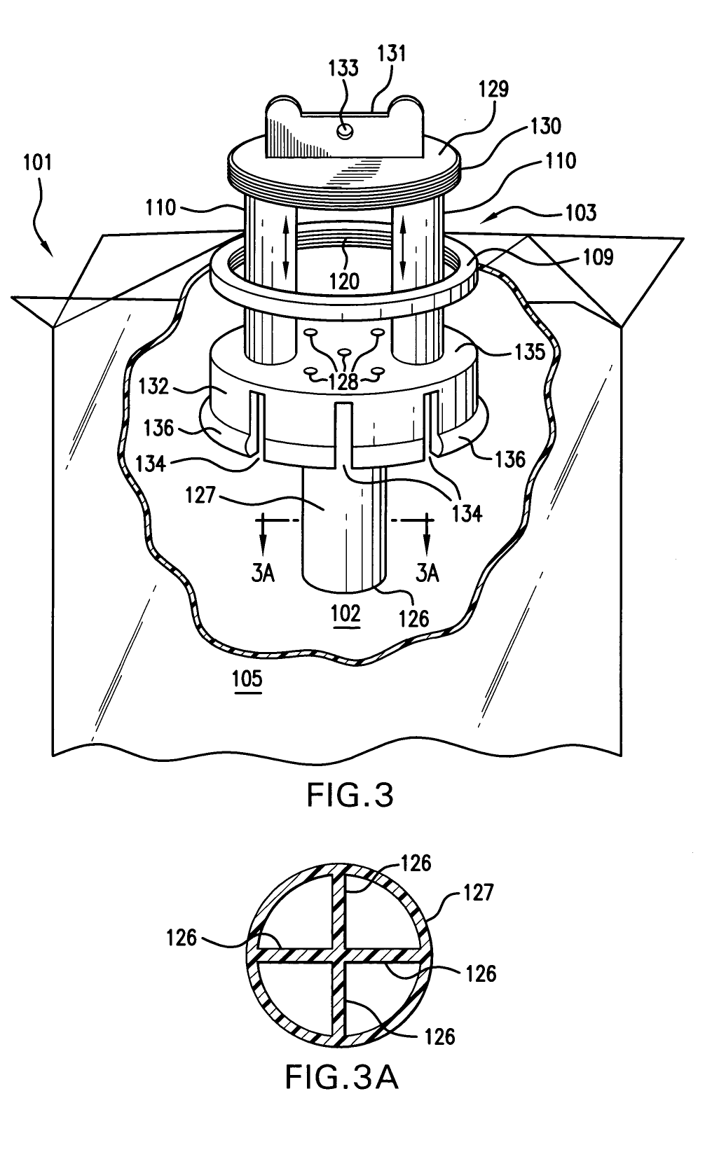

FIG. 3 is a perspective view, partially broken away, of another device of this invention.

FIG. 3A is a sectional view taken along line 3A-3A of FIG. 3

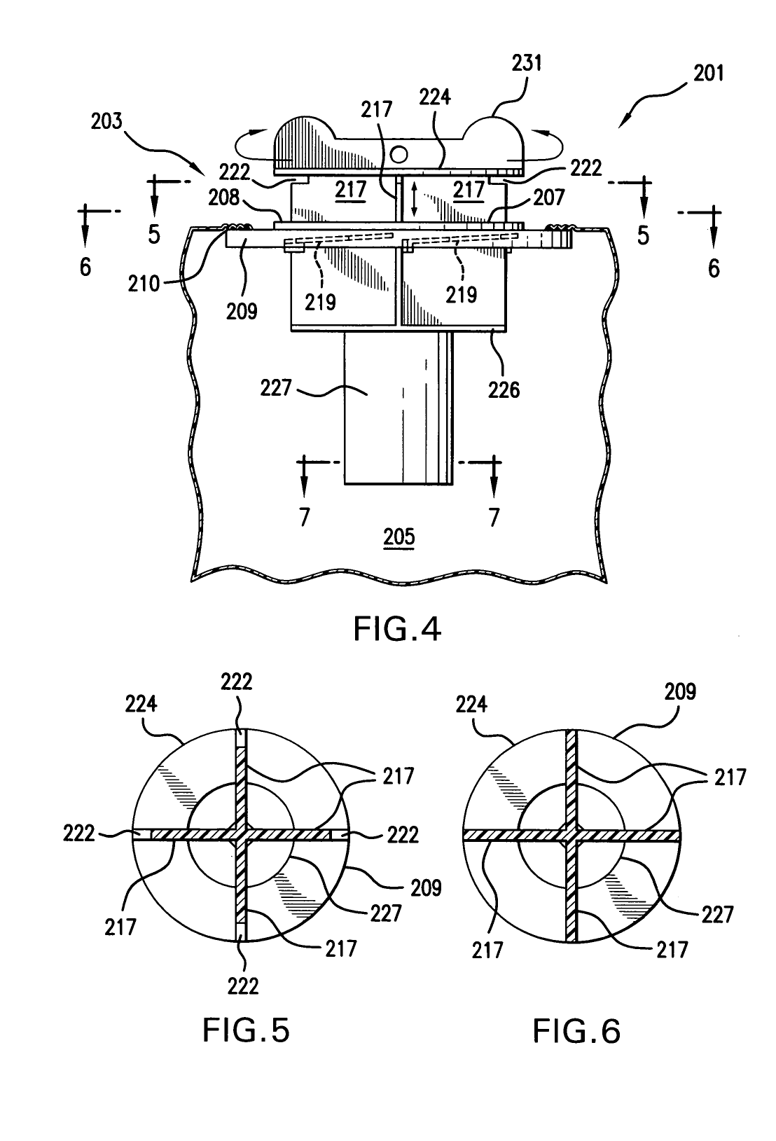

FIG. 4 is a view in side elevation of another device of this invention.

FIG. 5 is a sectional view taken along line 5-5 of FIG. 4.

FIG. 6 is a sectional view taken along line 6-6 of FIG. 4.

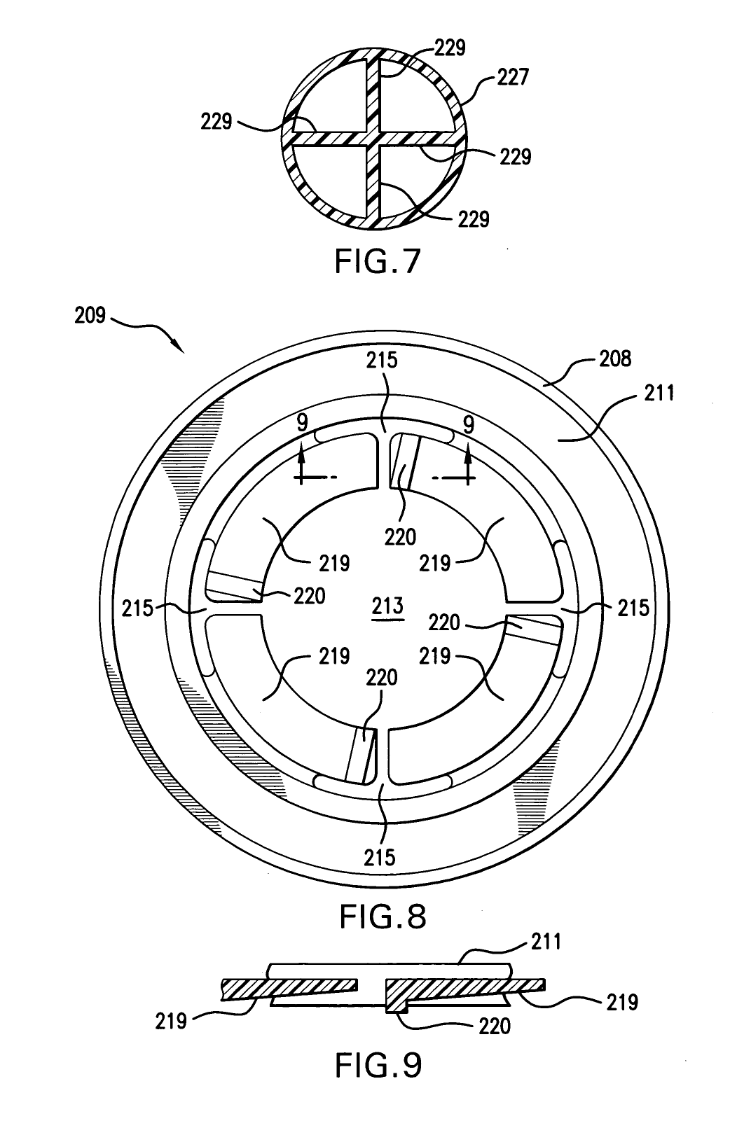

FIG. 7 is a sectional view taken along line 7-7 of FIG. 4.

FIG. 8 is a bottom plan view of a detail the locking ring of FIG. 4.

FIG. 9 is a sectional view taken along line 9-9 of FIG. 8.

### DETAILED DESCRIPTION OF THE INVENTION

Looking first at FIG. 1 there is illustrated a trap 11 of this invention in a rudimentary form. Here the insect trap 11 is essentially a container 13 having a neck 12 and a containment chamber 19. The container 13 is preferably made of transparent glass or plastic. It has been observed that an insect trap that is partially filled with insects is more effective in attracting other insects than is an empty one. A transparent trap is advantageous since insects outside of the trap can see the insects that are inside the trap.

The top of the container 13 has a vertical neck 12. The neck 12 includes a rim 15 and one or more orifices 18-18 that pass radially through the neck 12. A screw-on cap 14 is provided to close the trap 11.

The neck 12 carries external screw threads 17 which are adapted to engage internal screw threads 16 of the cap 14. As illustrated in FIG. 1 the insect trap 11 is essentially nothing more than a flask with a screw-on cap. It can be understood that the cap 14 can be screwed over the threads 17 of the neck 12. When internal threads of the cap engage the external threads 17 of the neck 12, the cap 14 can be advanced down the threads 17 until it passes over and closes the radial orifices 18-18 and finally seats in sealing relationship with the upper rim 15 of the neck 12. When the cap 14 is so seated the containment chamber 19 is hermetically sealed and no fluids can leave or enter or leave the trap 11.

When the rotation of the cap 14 is reversed, the radial passageways 18-18 are exposed allowing the trap to be placed in operation. Provision for the rotation of the cap 14 makes it possible for the cap 14 to be axially moved up and down on the neck 12 of the trap 11 which enables the trap 11 to be turned “on” or “off” as may be desired.

Another embodiment of a trap made in accordance with the invention is illustrated in FIG. 2. Here there is shown a containment chamber 29 defined by side walls 23 and a top plate 22. Vertically disposed orifices 28-28 are located in the top plate 22 to provide access to the containment chamber 29. Gases generated by attractants may leave the containment chamber 29 and insects can enter the containment chamber 29 by means of the orifices 28-28. The upper open portion of the containment chamber 23 is provided with external screw threads 27. These threads 27 are designed to engage internal threads 26 of the screw cap 24. To make the trap ready for use, that is turning it “on”, the cap 24 is rotated to back it off of the top plate 22 and permit the cap 24 to be removed from the trap 21. When the cap 24 is removed from the trap 21, vertical orifices 28-28 are exposed so that attractive odors can leave the contained chamber 29 and insects can enter the containment chamber 29. On the other hand, when one wants to turn the trap “off” the cap 24 is positioned over the top of the trap 21 and the internal threads 26 of the cap 24 are engaged with the external threads 27 of the containment chamber 29. Then rotation of the cap 24 will advance the cap 24 and the rotation can be continued until it is seated in sealing relationship with the top plate 22. When the cap 24 is so seated against the top plate 22 the contents of the trap are hermetically sealed within the containment chamber 29.

FIG. 2a is a view of the bottom side of the top plate 22 taken along line 2a-2a of FIG. 2. This provides an example of a suitable array of vertical orifices 28-28 as would be useful in the practice of the invention are here illustrated.

The insect traps shown and described in FIGS. 1 and 2, utilize a threaded cap that may be opened or closed by turning the cap relative to the top of the trap. This is a convenient way to obtain a hermetic seal, but other types of caps are also useful in the practice of the invention. A hinged lid with a positive latch mechanism would perform well as would a harness and leveraged type of sealing device as once was popular for use with jars used for “canning” fruits and vegetables in the home.

FIG. 3 illustrates an insect trap that is more sophisticated than those shown in FIG. 1 and 2. Here there is shown an insect trap 101 generally illustrated as comprising a containment bag 105, an entry fixture 103 and a closure member 129. The containment bag 105 is sealed with and supported by a locking ring 109. The closure member 129 is threaded on its outer circumference with external threads 130. Connecting rods 110-110 depend from the lower surface of the closure member 129 and are attached at their lower ends to the upper surface of a skirt 132. A baffle section 127, having a lower open end 126, provides a passageway from the interior of a containment chamber 102 extending to the region circumscribed by the locking ring 109. The internal structure of the baffle section 127 is shown in FIG. 3a. The baffle section 127 is substantially an open passageway in which baffles 126-126 are located and which extends up to the openings 128-128 in the upper surface of the skirt 132. Skirt 132s provided with a lower, radially extending circumferential rim 136. Slotted openings 134-134 are spaced around the skirt 132 and the rim 136.

Mounted on top of the closure member 129 is a hand grip 131 which aids a user in grasping the closure member 129. As shown in the drawing, an opening 133 is provided in the hand grip 131 through which a string or wire may be passed for hanging the trap 101.

The locking ring 109 contains internal threads 120 that are designed to engage the external threads 130 of the closure member 129 for rotation.

When it desired to seal the contents of the containment bag 105 within the containment chamber 102 (i.e. turn the trap “off”), as for storage, disposal or relocation, the threads 130 of the closure member 129 are engaged with the threads 120 of the sealing ring 109 and the closure member is rotated and advanced into sealing relationship with the locking ring 109. On the other hand, when it desired to place the trap in service (i.e. turn the trap “on”) the rotation of the closure member 129 is reversed to permit separation of the closure member 129 from the locking ring 109.

When the closure member 129 and locking ring 109 are disengaged from each other, they are moved apart until the locking ring 109 passes around the skirt 132 and come to rest on and is supported by the rim 136.

In the initial assembly of the trap, the locking ring 109 is forced up and over the rim 136 of the skirt 132. The slotted openings 134 allow the rim 136 to flex circumferentially inwardly to permit the rim 136 to be urged through the inner diameter of the locking ring 109.

The trap 101 illustrated in FIG. 3 includes a baffle section 127 which is configured to make it more difficult for trapped insects to find their way out of the containment chamber 102. As shown in FIG. 3a, the baffle section 127 includes baffle members 126-126 which define the several passageways 128-128.

When the trap 101 is turned “on” for use, the closure member 129 is unscrewed from the locking ring 109, the locking ring is moved downwardly from the closure member 129 until it seats on the rim 136. When so positioned, insects will have free access to the passageways 128-128 and can enter containment chamber 102 by way of the baffle section 127 to seek out the source of the odors emanating from the containment chamber 102. On the other hand, if and when the insects try to escape from the containment chamber 102, they must first navigate the baffle section 127 and then find their way out by crawling through the openings 128-128. This makes it much more difficult for insects to find their way out of the traps than it is for them to find their way into the traps.

And yet another embodiment of this invention is illustrated in FIG. 4 through FIG. 9. In these drawings like parts are given the same numerical designation.

With reference to FIGS. 4-9 there is shown a trap 201 comprised of an entry fixture 203 and containment bag 205. The entry fixture 203 is comprised of an entry port 207 and locking ring 209. The containment bag 205 is supported and hermetically sealed onto the circumferential rim portion 210 of the locking ring 209.

To better understand the operation of the entry fixture 203 and the entry port 207 it is useful first to describe the function of the locking ring 209 as is best illustrated in FIG. 8. The locking ring 209 is comprised of an annular plate 211 having a central opening 213. As here shown the annular plate 211 has four slots or openings 215-215 into upright baffle plates 217-217 (See FIG. 4) of the entry port 207 port are inserted and pass through the slots 215-215. The portions of the annular plate 211 circumferentially intermediate the slotted openings 215-215 define ramps 219-219. The ramps 219-219, beginning at the slotted openings 215-215 and extending in a counterclockwise direction (see FIG. 8) are of increasing thickness and terminate at the stops 220-220. This can he viewed in FIG. 9 wherein the increasing thickness of the ramps 219-219 is illustrated terminating at the stops 220-220.

The entry port 207 is engaged in sliding relationship with the locking ring 209. From the views shown in FIG. 5 and FIG. 6 it will be seen that the entry port 207 is provided with four vertical baffles 217-217. The baffles 217-217 are made to fit into and slide vertically within the slotted openings 215-215 of the locking ring 209. Note the dual headed arrow shown in FIG. 4 that indicates that the entry port 207 is mounted to slide up and down in the locking ring 209.

The baffles 217-217 in the upper portion of the entry port 207 are notched 222-222 at their upper ends. These notches 222-222 enable the entry port 207 to rotate relative to the locking ring 209 when the locking ring 209 is moved into its upper position and pressed against the lid 224 of the entry port 207. While not illustrated in the drawings, an annular gasket may be interposed between the upper surface of the locking ring 209 and the underside of the lid 224. A gasket will aid in establishing a tight seal between the locking ring 209 and the lid 224.

When the trap 201 is prepared for use, the entry port 207 is rotated relative to the locking ring 209 until the baffles 217-217 are aligned with the slots 215-215. The entry port 207 is then moved upwardly with respect to the locking ring 209 until it seats against the support plate 226 of the locking ring 209. The support plate 226 also serves as the lower terminus of the baffle plates 217-217. When water is added to the trap 201, gravity will hold the containment bag 205 and its locking ring 209 in contact with the support plate 226.

A lower section 227 of the entry port 207 is attached to and depends from the support plate 226 of the entry port 207. The lower section 226 is a hollow structure that is in free communication with the upper portion of the entry port 207. The lower section 227 surrounds baffles 229-229 that are designed to provide insects with ready entry to the containment bag 5 but make it more difficult for them to find their way out. The entry port 207 is closed at its top by a lid 224 which has a fixture 231 as a convenience in hanging the trap.

When the containment bag 205 is filled with insects, the entry port 207 is moved downwardly with respect to the locking ring 209 until the lid 224 rest flush on the upper surface of the locking ring 209. This permits the entry port 207 to rotate relative to the locking ring 209 within the notches 222-222 and slide along the inclined ramps until seated against the stops 220-220. This mechanical movement establishes a hermetic seal which turns the trap 201 “off” to permit the trap 201 it to be moved or disposed without concern for the escape of any of the noxious materials and insects from the containment bag 205.

Another feature of the trap 201 illustrated in FIG. 4 is the ease by which it can he fabricated and assembled. For convenience, and almost necessity, the entry port 207 and the locking ring 209 are separately made and then assembled for use in the invention. This is facilitated by making the locking ring 209 of a deformable, resilient material. This permits the ramps 219-219 to flex sufficiently to permit the locking ring 209 to be forced through the slotted openings 215-215. After this procedure is repeated at each of the ramps 219-219, the locking ring 209 will be mounted in surrounding relationship to the entry port 207 and its baffles 217.

In summary, the insect traps of this invention are provided with sealing means that can be made airtight for storage, handling and disposal or, at the will of the user opened to place the trap in use. The sealing means are not of the type that must be destructively removed to open the trap and the trap can be returned to the sealed condition after the trap has been opened. The airtight seal provides a number of benefits. These include providing a longer shelf life for unused traps and the advantages of being able to turn the trap “off” after it has been used and turned “on” for reuse. When sealed or turned “off” the trap may be moved from one location to another without any spillage from the trap; it may be disposed of without placing the health of the user at risk or contaminating the environment; and it will no longer be an attractant to insects, as upon the disposal of the trap.

The traps illustrated in the drawings utilize fixtures for opening and closing the traps by the rotation of one part relative to another. As previously mentioned other types of closure methods for turning the traps “on” and “off” can be used. Devices that may be sealed by friction, such as stoppers with elastic properties, may be used. The essential feature of any closure member is that it must seal the contents of the trap with sufficient security to maintain a hermetic seal even when pressures develop within the trap when it is in the “off” position. Other modifications that will accomplish the same purpose of achieving a seal may suggest themselves to those skilled in the art without departing from the objects of the invention. It is intended that all such modifications be included within the scope of the invention claimed herein.

1. An insect trap with airtight sealing means that can be opened and resealed.

2. An insect trap according to claim 1 in which a containment chamber is in communication with the sealing means.

3. An insect trap according to claim 1 in which the sealing means includes an orifice means.

4. An insect trap according to claim 3 in which the sealing means insect attractants may leave the trap and insects may enter the trap when the sealing means is open.

5. An insect trap according to claim 4 in which the sealing means includes an impervious closure member

6. An insect trap according to claim 5 in which the closure member and the orifice means can be rotated relative to each other.

7. An insect trap according to claim 6 in which the trap can be opened or sealed by rotation of the closure member relative to the orifice means.

8. An insect trap according to claim 6 in which rotation of the closure means in one direction causes the closure member to engage the orifice means in sealing frictional engagement with each other.

9. An insect trap according to claim 6 in which rotation of the closure means in one direction relative to the closure means advances the closure member along an inclined ramp and into sealing frictional engagement with each other.

10. An insect trap according to claim 5 in which a baffle means is associated with the closure member.

11. An insect trap according to claim 10 in which the baffle means provides access of an insect into the containment chamber of the trap but diminishes the ability of the insect to find its way out of the containment chamber.

12. An insect trap according to claim 10 in which the baffle is affixed to the lower surface of the closure member and engages the orifice means in sliding relationship.

13. An insect trap according to claim 3 in which an impervious closure member is adapted for insertion over the orifice means.

14. A disposable insect trap characterized in that it maybe alternatively be turned “on” and “off.”

15. A disposable insect trap according to claim 14 in which an impervious closure means is engaged with an orifice and the orifice communicates with a containment chamber.

16. A disposable insect trap according to claim 15 in which the impervious closure means and the orifice are engaged in threaded relationship with each other.

17. A disposable insect trap according to claim 16 in which a skirt depends from and is spaced away from the impervious closure member.

18. A disposable insect trap according to claim 17 in which the outer diameter of the skirt is essentially the some as the inside circumference of the orifice.

19. A disposable insect trap according to claim 18 in which the lower rim of the skirt is of a larger circumference than the inside circumference of the orifice.

20. A disposable insect trap according to claim 15 in which the impervious closure means is adapted to seat in frictional engagement with the orifice.
